(19) United States
(12) Patent Application Publication
(10) Pub. No.: US 2019/0025500 A1
(43) Pub. Date: Jan. 24, 2019

(54) LAMINATED LIGHT DIFFUSING OPTICAL FIBER

(71) Applicant: CORNING INCORPORATED, CORNING, NY (US)

(72) Inventors: Vikram Bhatia, Painted Post, NY (US); Eric Donald Dvorak, Fort Worth, TX (US); Paul George Rickerl, Endicott, NY (US)

(73) Assignee: CORNING INCORPORATED, CORNING, NY (US)

(21) Appl. No.: 16/066,906

(22) PCT Filed: Jan. 5, 2017
(86) PCT No.: PCT/US17/12255

§ 371 Date: Jun. 28, 2018

Related U.S. Application Data
(60) Provisional application No. 62/274,849, filed on Jan. 5, 2016.

(51) Int. Cl. F21V 8/00; B32B 17/10

(52) U.S. Cl. CPC G02B 6/0095; B32B 17/10036; B32B 17/10091; B32B 17/10788; G02B 6/0005; B32B 17/10761; B32B 17/1077; B32B 17/10541

(57) ABSTRACT

An illuminated vehicle window is provided. The illuminated window has a first layer of tempered glass; a second layer of tempered glass; a binding layer between the first and second layers of tempered glass; a channel located in the binding layer and between the first and second layers of tempered glass; a light diffusing optical fiber (LDF) located in the channel; and a light source operably connected to the LDF. Also provided is an illuminated multi-layer glass structure. Further provided is a laminated light diffusing fiber (LDF) device in which the channel and LDF define a design in the binding layer and in which the width of the channel is at least 5% greater than the diameter of the LDF.

### CROSS-REFERENCE TO RELATED APPLICATIONS

This application claims the benefit of priority under 35 U.S.C. § 119 of U.S. Provisional Application Ser. No. 62/274,849 filed on Jan. 5, 2016 the content of which is relied upon and incorporated herein by reference in its entirety.

### BACKGROUND

The disclosure relates generally to light diffusing optical fibers and more particularly to a device, such as a window, mirror, display, etc., incorporating one or more light diffusing optical fibers. Optical cables carry light. In some applications, the light is used to transmit information. However, the optical cables can be configured to emit the light that they carry.

### SUMMARY

One embodiment of the disclosure relates to an illuminated vehicle window. The illuminated vehicle window includes a first layer of tempered glass and a second layer of tempered glass. The illuminated vehicle window includes a binding layer between the first and second layers of tempered glass and a channel located in the binding layer and between the first and second layers of tempered glass. The illuminated vehicle window includes a light diffusing optical fiber (LDF) located in the channel and a light source operably connected to the LDF.

An additional embodiment of the disclosure relates to an illuminated multi-layer glass structure including a first glass layer having an inner surface and an outer surface and a second glass layer having an inner surface and an outer surface. The illuminated multi-layer glass structure includes a channel located between the inner surfaces of the first and second glass layers and a binding layer between the inner surfaces of the first and second glass layers. The illuminated multi-layer glass structure includes a channel formed in the binding layer and a light diffusing optical fiber (LDF) located in the channel.

An additional embodiment of the disclosure relates to a laminated light diffusing fiber (LDF) device having a first light transmitting layer and a second light transmitting layer. The laminated LDF device includes a binding layer between the first and second light transmitting layers and a channel having a width and the channel being located in the binding layer between the first and second layers. The laminated LDF device includes an LDF having a diameter and being located in the channel. The channel and LDF define a design in the binding layer, and the width of the channel is at least 5% greater than the diameter of the LDF.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1A is an illuminated LDF device according to an exemplary embodiment.

FIG. 1B is a detail view of the illuminated LDF device of FIG. 1A according to an exemplary embodiment.

FIG. 2A is a cross-sectional view of the illuminated LDF device shown in FIGS. 1A and 1B according to an exemplary embodiment.

FIG. 2B is a cross-section view of another embodiment of the illuminated LDF according to an exemplary embodiment.

FIG. 3 provides a representation of light traveling through an LDF having a transport fiber region and a light emitting region according to an exemplary embodiment.

FIG. 4 provides a sectional view of an illuminated LDF device having more than one binding layer according to an exemplary embodiment.

FIGS. 5A-B provide schematic representations of an illuminated LDF device system according to exemplary embodiments.

FIGS. 6A-E depict various illuminated LDF device designs as used in an automotive context according to exemplary embodiments.

### DETAILED DESCRIPTION

Referring generally to the figures, various embodiments of an illuminated LDF device, such as a glass laminated light-diffusing optical fiber (LDF), an LDF illuminated window, an LDF illuminated glass structure, etc., are depicted. The illuminated LDF device generally comprises two outer layers of a transparent material, such as glass sheets, with at least one binding layer between the two outer layers. A channel that contains an LDF is located between the two outer layers. In an embodiment, the channel creates a design or shape that can be discerned by a viewer when the LDF is activated/illuminated. Otherwise, when deactivated, the design is substantially transparent. In one embodiment, the illuminated LDF device is used to convey information in an automotive context to the driver of a vehicle, those around the vehicle, and/or to other vehicles. In other embodiments, the LDF device is used to embed a light source for illumination (similar to a vehicle dome light) within automotive glass, such as glass forming a sun roof. In other embodiments, the illuminated LDF device is used for aesthetic purposes, such as in architectural designs, marketing displays, and/or customization of automotive features. However, those skilled in the art will recognize from the following description that such embodiments are provided by way of example only, not by way of limitation, and that all alternative embodiments and applications are reserved herein.

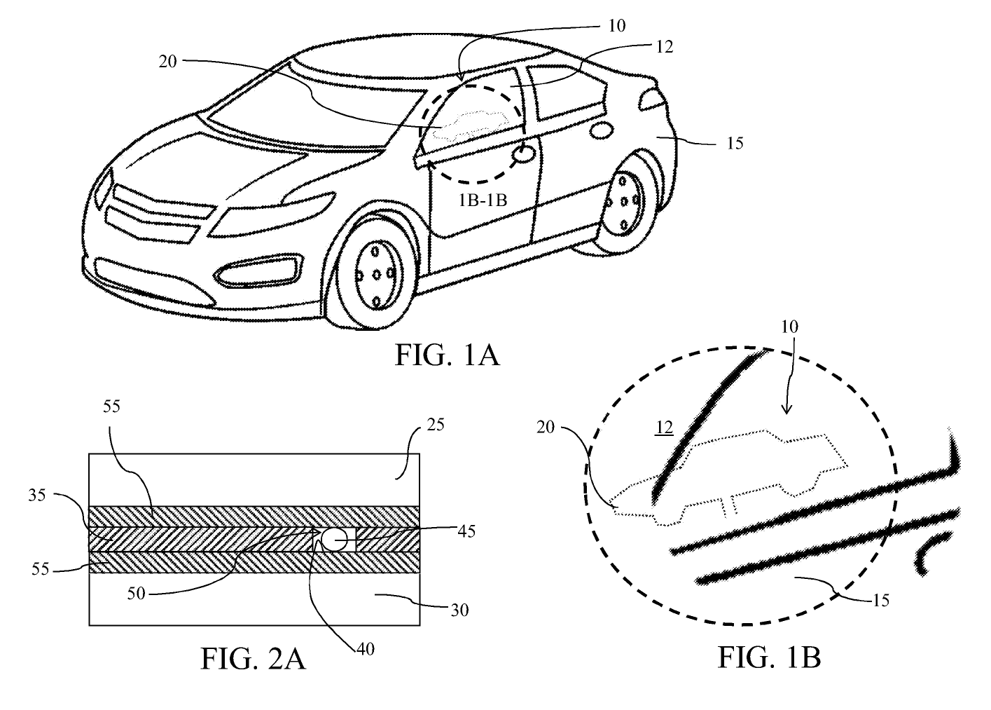

FIG. 1 provides an embodiment of the illuminated LDF device 10 as used in an automotive context. The illuminated LDF device 10 defines a window 12 of a vehicle 15. In this instance, the window 12 is the driver-side window of the vehicle 15. The illuminated LDF device 10 features an embedded design 20. In certain embodiments, the term “design” refers to any aesthetic, informational, and/or cautionary display whether in the form of alphanumeric characters, pictures, shapes, and/or lights. A detailed view of the design 20 can be seen in FIG. 1B.

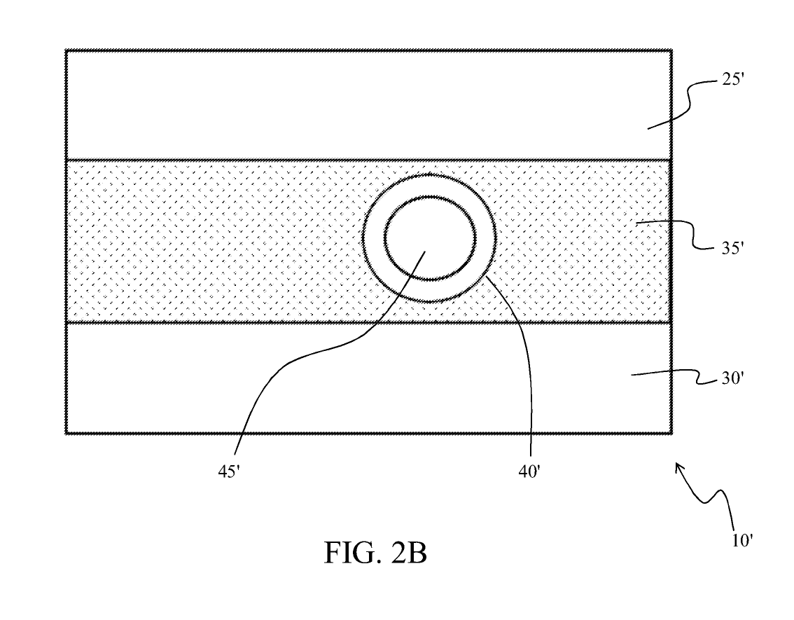

FIG. 2A provides a cross-sectional view of the illuminated LDF device 10 shown in FIG. 1B. The illuminated LDF device 10 includes a first layer 25 and a second layer 30. The first layer 25 and second layer 30 are configured to transmit light, such as visible spectrum light. In an embodiment, the first layer 25 and second layer 30 are substantially transparent such that they transmit at least 90% of incident visible spectrum light, and more specifically may transmit at least 95% of incident visible spectrum light. A binding layer 35 is provided between the first layer 25 and the second layer 30. A channel 40 is also included between the first layer 25 and second layer 30, which is shaped so as to form the design 20. In one embodiment, the channel 40 is formed into the binding layer 35. In a particular embodiment, the channel 40 has a depth that equals the thickness of the binding layer 35. An LDF 45 is located inside the channel 40. In certain embodiments, the LDF 45 has a diameter between 150 μm and 500 μm, and in a specific embodiment, the LDF 45 has a diameter of 270 μm. As shown in FIG. 2, the LDF 45 is surrounded at least in part by a region 50 such that the LDF 45 is not molded into the binding layer 35. In certain embodiments, the region 50 is a space surrounding at least a portion of the LDF 45 that has a different refractive index than the LDF 45, such as vacuum, air, or a substantially non-reactive gas, including helium, neon, argon, nitrogen, and carbon dioxide. In other embodiments, the region 50 is another solid, fluid, or gelatinous material. As further shown in FIG. 2A, the illuminated LDF device 10 can further comprise additional resin layers 55.

FIG. 2B shows another embodiment of the illuminated LDF device 10′. As in the previous embodiment, the binding layer 35′ is provided between the first layer 25′ and the second layer 30′. However, the LDF 45′ in this embodiment is located in a tube 40′. In the specific embodiment shown in FIG. 2B, the binding layer 35′ surrounds the tube 40′. A region 50′ surrounds the LDF 45′, and as in the previous embodiment, the region can be vacuum, air, a substantially non-reactive gas, or another solid, fluid, or gelatinous material. In certain embodiments, the tube 40′ has an inside diameter of between 1 mm and 500 μm, and in a specific embodiment, the tube 40′ has an inside diameter 700 μm. In still another embodiment, the LDF 45′ is contained in the tube 40′, which is further located in a channel 40.

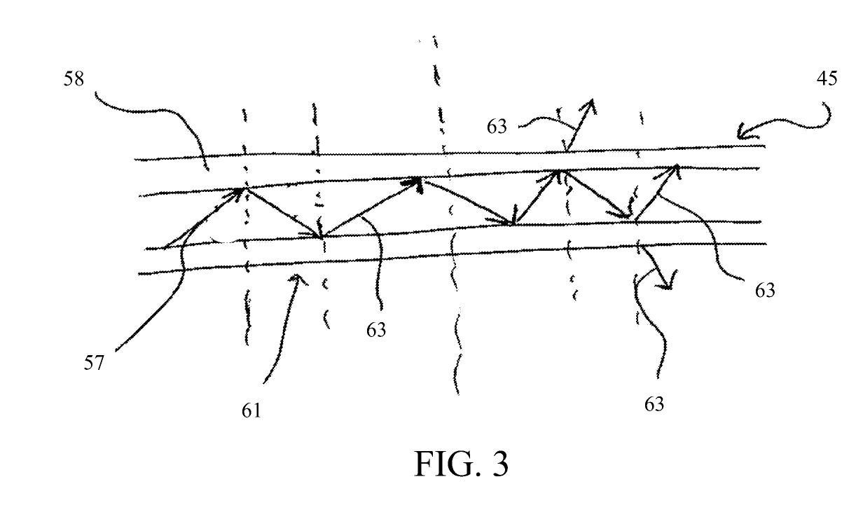

In one embodiment, the LDF 45 is glass optical fiber. In another embodiment, the LDF 45 is plastic optical fiber. In a particular embodiment represented in FIG. 3, the LDF 45 is a glass optical fiber having a core 57 and a cladding layer 58.

As represented in FIG. 3, the LDF 45 is divided into a first region in which light is not emitted and a second region in which light is emitted. In one embodiment, the first region in which light is not emitted is transport fiber 61 in which light 63 traveling along the LDF 45 is substantially reflected by the cladding layer 58 such that most of the light remains in the core 57. The reflection of light 63 in the transport fiber 61 occurs because the refractive index of the cladding layer 58 is different than the refractive index of the core 57, such that light travels along transport fiber 61 via total internal reflection. In an embodiment, the amount of light signal lost along the transport fiber 61 is less than 1 dB/km for electromagnetic radiation at any wavelength between 1 mm and 10 nm, and more particularly electromagnetic radiation at any wavelength between 1500 nm and 100 nm, i.e., light substantially within the infrared to ultraviolet spectrum.

In the second region, LDF 45 is configured such that light 63 is emitted from the LDF 45. In certain embodiments, light signal is lost, i.e., emitted from the LDF 45, at a rate of up to 300 dB/m. In other embodiments, the light signal is lost in the LDF at a rate of between 1 dB/m and 10 dB/m. In various embodiments, a portion of LDF 45 with the second region, e.g., the cladding layer 58, core 57, etc., is modified such that a lower amount of total internal reflection occurs within the second region allowing a portion of light 63 to be transmitted out from LDF 45 into region 50. In a specific embodiment, the portion of the LDF 45 that emits light is modified through laser ablation to allow light 63 to be transmitted out from the LDF 45 into region 50. In a more specific embodiment, the LDF 45 is coated with a first polymer layer, and at least a portion of the first polymer layer and/or cladding layer 58 is removed during laser ablation before the application of a second polymer layer around the LDF. In another specific embodiment, the microstructure of the LDF 45 is modified to include scattering points such that light 63 can be transmitted out from the LDF 45 into region 50. Further, in one embodiment, light emits evenly from the LDF 45, i.e., light emits 360° around the perimeter of the LDF along the length of the light emitting portion of the LDF. In another embodiment, however, light emits at only in specific directions around the LDF such that the light has directionality when emitted from certain regions of the LDF perimeter.

“Light” as used herein refers primarily to electromagnetic radiation between the wavelengths of about 100 nm to about 1500 nm. This range of spectrum includes a majority of the infrared, visible, and ultraviolet spectrums. In some embodiments, the LDF 45 carries light in the infrared or ultraviolet spectrums to provide signals that are not otherwise distracting or visible to the human eye. In other embodiments, the LDF 45 carries light in the visible spectrum specifically for illumination, to alert a viewer, or to attract a viewer's attention.

In an automotive context, the window or windows comprised of the illuminated LDF device 10 are structured to withstand conditions that are typically encountered by a vehicle. In this regard, the illuminated LDF device is designed to withstand inclement weather and flying/falling debris, such as rocks or tree limbs, without shattering or by breaking into small, non-jagged pieces. Accordingly, in an embodiment of the illuminated LDF device 10, the first layer 25 and second layer 30 are made of tempered glass. The tempering can be thermal tempering, chemical tempering, such as ion-exchange tempering, or a combination of thermal and chemical tempering. In specific examples, one or both of the first layer 25 and second layer 30 can be made of an alkali aluminosilicate glass, such as Corning's GORILLA® glass. In another embodiment, the first and second layer 25, 30 can be soda lime glass. In a specific embodiment, the binding layer 35 is polyvinyl butyral (PVB). In other embodiments, the binding layer 35 is a modified PVB, such as acoustic PVB, which is designed to reduce sound transmission through the illuminated LDF device by a certain amount, e.g., PVB designed to reduce sound transmission through the illuminated LDF device by up to 5 dBs, or solar radiation limiting PVB, which is designed to reduce infrared transmission through the illuminated LDF device from solar radiation, e.g., PVB designed to transmit less than 30% of infrared radiation from the sun through the illuminated LDF device. In still another embodiment, the binding layer 35 is ethylene vinyl acetate. In certain embodiments, the first layer 25 and second layer 30 have refractive indices that match the refractive index of the binding layer 35, i.e., the refractive indices are within 0.1 of each other. The resin layer 55, when provided, can be any of a variety of thermoplastic urethanes.

In certain embodiments, the illuminated LDF device 10 is between 2 mm and 10 mm thick, specifically, between 2 mm and 5 mm thick, and more specifically is about 2.92 mm thick (e.g., 2.92 mm thick plus or minus 10%). In such embodiments, the first layer 25, second layer 30, and binding layer 35 are all between 0.4 mm and 3.5 mm thick. In a specific embodiment, the first layer 25 and second layer 30 are 0.7 mm thick (e.g., 0.7 mm thick plus or minus 1%), and the binding layer 35 is 0.76 mm thick (e.g., 0.76 mm thick plus or minus 10%). Each resin layer is between 0.25 mm and 1.25 mm thick, specifically between 0.2 mm and 0.6 mm thick, and more specifically is about 0.38 mm thick (e.g., 0.38 mm thick plus or minus 10%).

In assembling the illuminated LDF device 10, the binding layer 35 is applied to the second layer 30. In some embodiments, the channel 40 is formed into the binding layer 35 by etching, carving, or otherwise removing the binding layer material from the second layer 30. In other embodiments, binding layer 35 is applied, deposited or molded between layers 25 and/or 30 in a pattern such that channel 40 is formed from an open area surrounded by binding layer 35. In an embodiment, the channel 40 has a depth of between 0.5 mm and 3.5 mm. The width of the channel 40 is sufficient such that the region 50 is provided around the LDF 45. Thus, in various embodiments, the width of the channel 40 varies between about 0.7 mm and about 1 mm; however, in other embodiments, a wider channel 40 is provided such that multiple LDFs 45 are able to reside in the channel 40. In one embodiment, the width of the channel 40 is at least 5% greater than, and more specifically at least 25% greater than the diameter of the LDF 45.

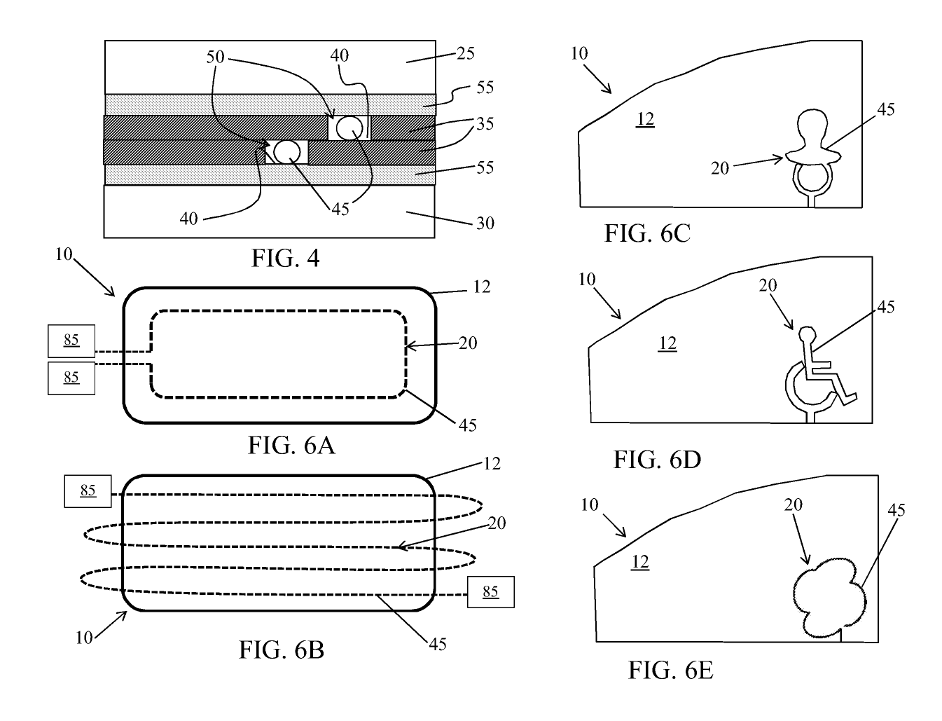

Additionally, in another embodiment depicted in FIG. 4, multiple binding layers 35 are provided such that different channels 40 each with its own LDF 45 are formed into the different binding layers 35. In such embodiments, each channel 40 may define a different design or different design element.

Returning to FIG. 1B, the design 20 of the illuminated LDF device 10 is the outline of a car. In an embodiment, the design 20 is used to warn the driver of a vehicle that another vehicle is in the driver's blind spot. Thus, the design 20 is illuminated when sensors on the driver's vehicle detect the presence of another vehicle in the driver's blind spot. This embodiment will be described as an exemplary embodiment to facilitate discussion of certain functional aspects of the illuminated LDF device 10, but is not meant to limit the range of embodiments or applications to which the illuminated LDF device 10 can be applied.

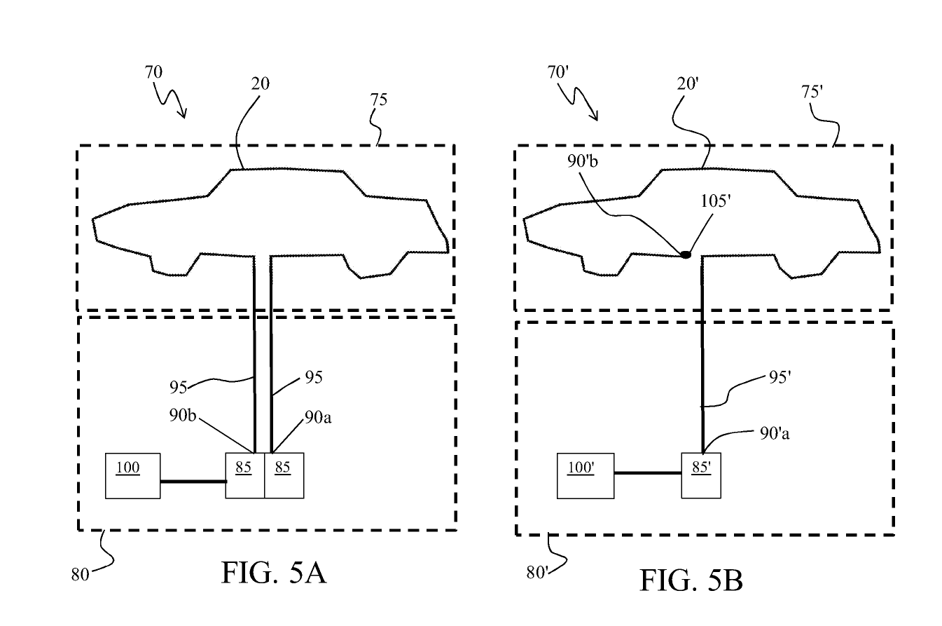

FIG. 5A provides a first schematic illustration of an illuminated LDF device system 70, which could be used for a blind spot detection system. The design 20 includes a visible portion 75 of the system 70. A hidden portion 80 of the system 70 includes two light sources 85. In the blind spot detection embodiment, the light sources 85 can be hidden, for instance, in the driver side door of a vehicle. The LDF 45 has two terminal ends 90a, 90b, and each terminal end 90a, 90b is connected to a light source 85. Light from the light sources 85 travels to the design 20 via lead fibers 95. As used herein, the lead fibers 95 are the portion of the LDF 45 that are not part of the design 20 but only carry light from the light source 85 to the design 20. The lead fibers 95 may or may not emit light while carrying the light to the design 20. In one embodiment, though, the lead fibers 95 are transport fibers 61 that do not emit light. The light sources 85 are connected to a sensor or sensors 100, such as a proximity sensor in the case of a blind spot detector. When the sensor 100 detects a vehicle in the driver's blind spot, the light sources 85 are activated, which supplies light to the LDF 45 and lights up the design 20. The illuminated design 20 warns the driver that another vehicle may be in the driver's blind spot.

FIG. 5B provides a second schematic illustration of the illuminated LDF device system 70′. In this embodiment, only a single light source 85′ is provided, such that only one terminal end 90′a is connected to the light source 85′. The light source 85′ is connected to a sensor 100′ such that, in response to a stimulus, sensor 100′ actuates the light source 85′, causing light to travel through the lead fiber 95′ to the design 20′. The second terminal end 90′b is not connected to a light source and, in one embodiment, includes a cap or other highly diffusive or absorbing region 105′ to diminish the intensity and directionality of the light once the second terminal end 90′b is reached.

In one embodiment, each light source 85 is a multi-spectrum source and/or a single source laser, such as a red-green-blue laser that can supply a variety of colors of light, including individual red, green, and blue light, or individual lasers that supply a light of a single wavelength. In another embodiment, the light source 85 is one or more LEDs. In still other embodiments, the light source 85 is an infrared laser, ultraviolet laser, infrared LED, or ultraviolet LED. In a further embodiment, the LDF 45 is coated in sections with one or more phosphors. In this way, a single source laser having a high energy (i.e., low wavelength), such as a blue laser, can be used as the light source for the LDF such that different colors of light can be emitted along the length of the LDF.

The illuminated LDF device is able to provide a clearly defined illuminated design to a viewer. The placement of the LDF 45 within the channel 40 or tube 40′ provides an intensity profile over the surface of the illuminated LDF device such that the intensity of light emitted from the illuminated LDF device is greatest within the spatial extent defined by the channel 40, tube 40′, or both. Thus, for example, as intensity is traced from an edge of the illuminated LDF device, spikes of intensity would be encountered in the regions of the illuminated LDF device featuring the channel 40, tube 40′, or both.

Various embodiments of the illuminated LDF device 10 as used in an automotive context are provided in FIGS. 6A-6E. FIG. 6A depicts a window 12 of a vehicle in which the LDF 45 defines a design 20 that follows the contour of the window 12 and is inset from the perimeter of the window 12. FIG. 6B depicts a window 12 of a vehicle in which the LDF 45 defines a design 20 that is a series of stripes across the window 12. In the embodiments depicted in FIGS. 6A and 6B, the LDF 45 has a light source 85 on each end; however, in other embodiments, a single light source is used. In certain embodiments, the windows 12 shown in FIGS. 6A and 6B are sunroofs of a vehicle such that activation of the light source 85 creates ambiance or aesthetic lighting effect from the light provided by the LDF 45. In other embodiments, such LDF 45 and/or light source 85 is configured such that activation of the LDF 45 act as an overhead dome light for the vehicle interior. In other embodiments, the windows 12 shown in FIGS. 6A and 6B are back windows, and the LDF 45 illuminates when the brakes of the vehicle are engaged. In this way, the back window is configured to act as an additional brake light alert to drivers following the vehicle. While the embodiments depicted in FIGS. 6A and 6B have two light sources, they could instead have a single light source.

FIGS. 6C-6E depict embodiments of the illuminated LDF device in which the design 20 is used to convey characteristic information about the driver or passengers of the vehicle. In one embodiment of the illuminated LDF device 10 on a window 12 shown in FIG. 6C, the LDF 45 is configured as a design 20 shaped like a pacifier to convey that a baby is a passenger in the vehicle. In another embodiment of the illuminated LDF device 10 on a window 12 shown in FIG. 6D, the LDF 45 is configured as a design 20 shaped like a person in a wheelchair to convey that the driver has a disability or is permitted to park in handicapped-reserved parking spaces. In still another embodiment of the illuminated LDF device 10 on a window 12 shown in FIG. 6E, the LDF 45 is configured as a design 20 configured to convey the experience level of the driver. As shown in FIG. 6E, the design is a Koreisha mark, which is used in Japan to indicate that the driver of the vehicle is over 70 years old. Another possible design is the Shoshinsha mark, which is used in Japan to indicate that the driver received his or her license within the last year or is otherwise relatively inexperienced at driving. Each LDF in the embodiments embodiments depicted in FIGS. 6C-6E can have one or two light sources at the terminal ends of the LDF.

In another automotive embodiment, the illuminated LDF device emits non-visible light, e.g., infrared light, UV light, to signal other vehicles. For instance, the illuminated LDF device can be incorporated into various automated car systems or into self-driving cars to provide interactivity between multiple self-driving cars. Thus, one self-driving car can communicate with other self-driving cars or with structures on the road, such as traffic lights, tolls booths, and railroad crossings, to facilitate orderly and efficient operation of the self-driving cars on a road. In an embodiment, the illuminated LDF device modulates an infrared signal that is detected by other cars and structures on the road, which, in turn, interpret the signal and respond or react appropriately.

In further embodiments, the illuminated LDF device is incorporated into architectural or aesthetic designs. In one embodiment, the illuminated LDF device provides signage for a window of a business. In another embodiment, the illuminated LDF device provides customizable wall color for a building such that the illuminated LDF device can be illuminated in different colors.

Aspect (1) of this disclosure pertains to an illuminated vehicle window comprising: a first layer of tempered glass; a second layer of tempered glass; a binding layer between the first and second layers of tempered glass; a channel located in the binding layer and between the first and second layers of tempered glass; a light diffusing optical fiber (LDF) located in the channel capable of emitting light; and a light source operably connected to the LDF.

Aspect (2) of this disclosure pertains to the illuminated vehicle window of Aspect (1), wherein the light emitted from the LDF has a greater intensity in regions of the illuminated vehicle window where the channel is located.

Aspect (3) of this disclosure pertains to the illuminated vehicle window of Aspects (1) or (2), wherein the channel is a tube that has an inner diameter of between 1 mm and 500 μm.

Aspect (4) of this disclosure pertains to the illuminated vehicle window of any one of Aspects (1) through (3), wherein the first and second layer of tempered glass are chemically tempered, wherein at least one of the first and second layers of tempered glass is comprised of alkali aluminosilicate glass.

Aspect (5) of this disclosure pertains to the illuminated vehicle window of any one of Aspects (1) through (4), further comprising a first resin layer between the first layer of tempered glass and the binding layer and a second resin layer between the second layer of tempered glass and the binding layer, wherein the first resin layer has a refractive index between the refractive indices of the first layer of tempered glass and the binding layer and the second resin layer has a refractive index between the refractive indices of the second layer of tempered glass and the binding layer.

Aspect (6) of this disclosure pertains to the illuminated vehicle window of any one of Aspects (1) through (5), wherein the binding layer is polyvinylbutyral.

Aspect (7) of this disclosure pertains to the illuminated vehicle window of any one of Aspects (1) through (6), further comprising a transport optical fiber communicably coupled between the LDF and the light source, the transport optical fiber provides a light signal loss of less than 1 dB/km.

Aspect (8) of this disclosure pertains to the illuminated vehicle window of any one of Aspects (1) through (7), wherein the LDF includes a cladding layer and a plurality of laser-ablated sections in the cladding layer.

Aspect (9) of this disclosure pertains to the illuminated vehicle window of any one of Aspects (1) through (8), wherein a region of the LDF includes a plurality of scattering points in a cladding layer of the LDF.

Aspect (10) of this disclosure pertains to the illuminated vehicle window of any one of Aspects (1) through (9), wherein the light source can be selectively activated and wherein the LDF is substantially transparent such that visible spectrum light is transmittable through the first and second layers of tempered glass and through the LDF.

Aspect (11) of this disclosure pertains to the illuminated vehicle window of any one of Aspects (1) through (10), wherein the window is mounted through a roof of a vehicle and wherein the light source is activated and the LDF illuminated to illuminate the interior of the vehicle.

Aspect (12) of this disclosure pertains to the illuminated vehicle window of any one of Aspects (1) through (11), wherein the light source is configured to be activated to illuminate the LDF in response to a signal from a vehicle blind-spot sensor.

Aspect (13) of this disclosure pertains to the illuminated vehicle window of any one of Aspects (1) through (12, wherein the LDF is configured as at least one of a brake light on a rear window of a vehicle, a handicap sign on a window of a vehicle, a driver characteristic display on a window of a vehicle, and an emitter of ultraviolet or infrared light to facilitate vehicle-to-vehicle communication.

Aspect (14) of this disclosure pertains to an illuminated multi-layer glass structure comprising: a first glass layer having an inner surface and an outer surface; a second glass layer having an inner surface and an outer surface; a channel located between the inner surfaces of the first and second glass layers; and a light diffusing optical fiber (LDF) located in the channel.

Aspect (15) of this disclosure pertains to the illuminated multi-layer glass structure of Aspect (14), further comprising a binding layer between the inner surfaces of the first and second glass layers, wherein the channel is formed at least in part in the binding layer and extends through the thickness of the binding layer such that a thickness of the channel is equal to or greater than a thickness of the binding layer; wherein a region is defined in a space located between the LDF and the binding layer.

Aspect (16) of this disclosure pertains to the illuminated multi-layer glass structure of Aspect (14) or Aspect (15), wherein the channel is a tube.

Aspect (17) of this disclosure pertains to the illuminated multi-layer glass structure of Aspect (16), wherein tube has an inner diameter of between 1 mm and 500 μm.

Aspect (18) of this disclosure pertains to the illuminated multi-layer glass structure of any one of Aspect (16) or Aspect (17), wherein the binding layer completely surrounds the tube.

Aspect (19) of this disclosure pertains to the illuminated multi-layer glass structure of Aspect (18), wherein the first glass layer and second glass layer have a refractive index n₁ and the binding layer has a refractive index n₂ and wherein n₁-n₂ is less than or equal to 0.1.

Aspect (20) of this disclosure pertains to a laminated light diffusing fiber (LDF) device comprising: a first light transmitting layer; a second light transmitting layer; a binding layer between the first and second light transmitting layers; a channel having a width, the channel being located in the binding layer between the first and second layers; and an LDF having a diameter, the LDF being located in the channel, wherein the channel and LDF define a design in the binding layer and wherein the width of the channel is at least 5% greater than the diameter of the LDF.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein the article “a” is intended include one or more than one component or element, and is not intended to be construed as meaning only one.

It will be apparent to those skilled in the art that various modifications and variations can be made without departing from the spirit or scope of the disclosed embodiments. Since modifications combinations, sub-combinations and variations of the disclosed embodiments incorporating the spirit and substance of the embodiments may occur to persons skilled in the art, the disclosed embodiments should be construed to include everything within the scope of the appended claims and their equivalents.

What is claimed is:

1. An illuminated vehicle window comprising:
a first layer of tempered glass;
a second layer of tempered glass;
a binding layer between the first and second layers of tempered glass;
a channel located in the binding layer and between the first and second layers of tempered glass;
a light diffusing optical fiber (LDF) located in the channel capable of emitting light; and
a light source operably connected to the LDF.

2. The illuminated vehicle window of claim 1, wherein the light emitted from the LDF has a greater intensity in regions of the illuminated vehicle window where the channel is located.

3. The illuminated vehicle window of claim 1, wherein the channel is a tube that has an inner diameter of between 1 mm and 500 μm.

4. The illuminated vehicle window of claim 1, wherein the first and second layer of tempered glass are chemically tempered, wherein at least one of the first and second layers of tempered glass is comprised of alkali aluminosilicate glass.

5. The illuminated vehicle window of claim 1, further comprising a first resin layer between the first layer of tempered glass and the binding layer and a second resin layer between the second layer of tempered glass and the binding layer, wherein the first resin layer has a refractive index between the refractive indices of the first layer of tempered glass and the binding layer and the second resin layer has a refractive index between the refractive indices of the second layer of tempered glass and the binding layer.

6. The illuminated vehicle window of claim 1, wherein the binding layer is polyvinylbutyral.

7. The illuminated vehicle window of claim 1, further comprising a transport optical fiber communicably coupled between the LDF and the light source, the transport optical fiber provides a light signal loss of less than 1 dB/km.

8. The illuminated vehicle window of claim 1, wherein the LDF includes a cladding layer and a plurality of laser-ablated sections in the cladding layer.

9. The illuminated vehicle window of claim 1, wherein a region of the LDF includes a plurality of scattering points in a cladding layer of the LDF.

10. The illuminated vehicle window of claim 1, wherein the light source can be selectively activated and wherein the LDF is substantially transparent such that visible spectrum light is transmittable through the first and second layers of tempered glass and through the LDF.

11. The illuminated vehicle window of claim 1, wherein the window is mounted through a roof of a vehicle and wherein the light source is activated and the LDF illuminated to illuminate the interior of the vehicle.

12. The illuminated vehicle window of claim 1, wherein the light source is configured to be activated to illuminate the LDF in response to a signal from a vehicle blind-spot sensor.

13. The illuminated vehicle window of claim 1, wherein the LDF is configured as at least one of a brake light on a rear window of a vehicle, a handicap sign on a window of a vehicle, a driver characteristic display on a window of a vehicle, and an emitter of ultraviolet or infrared light to facilitate vehicle-to-vehicle communication.

14. An illuminated multi-layer glass structure comprising:
a first glass layer having an inner surface and an outer surface;
a second glass layer having an inner surface and an outer surface;
a channel located between the inner surfaces of the first and second glass layers; and
a light diffusing optical fiber (LDF) located in the channel.

15. The illuminated multi-layer glass structure according to claim 14, further comprising a binding layer between the inner surfaces of the first and second glass layers, wherein the channel is formed at least in part in the binding layer and extends through the thickness of the binding layer such that a thickness of the channel is equal to or greater than a thickness of the binding layer;
wherein a region is defined in a space located between the LDF and the binding layer.

16. The illuminated multi-layer glass structure according to claim 14, wherein the channel is a tube.

17. The illuminated multi-layer glass structure according to claim 16, wherein tube has an inner diameter of between 1 mm and 500 μm.

18. The illuminated multi-layer glass structure according to claim 16, wherein the binding layer completely surrounds the tube.

19. The illuminated multi-layer glass structure according to claim 18, wherein the first glass layer and second glass layer have a refractive index n₁ and the binding layer has a refractive index n₂ and wherein n₁-n₂ is less than or equal to 0.1.

20. A laminated light diffusing fiber (LDF) device comprising:
a first light transmitting layer;
a second light transmitting layer;
a binding layer between the first and second light transmitting layers;
a channel having a width, the channel being located in the binding layer between the first and second layers; and
an LDF having a diameter, the LDF being located in the channel, wherein the channel and LDF define a design in the binding layer and wherein the width of the channel is at least 5% greater than the diameter of the LDF.
